(19) United States
(12) Patent Application Publication
(10) Pub. No.: US 2019/0005215 A1
(43) Pub. Date: Jan. 3, 2019

(54) METHOD FOR AUTHORISING AN ACTION BY INTERACTIVE AND INTUITIVE AUTHENTICATION OF A USER AND ASSOCIATED DEVICE

(71) Applicant: WORLDLINE, BEZONS (FR)

(72) Inventors: Denis FAIVRE, Lille (FR); Guillaume LEFEBVRE, Meurchin (FR); Maxime PERON, LESQUIN (FR); Mathieu BARTHELEMY, VIENNE (FR)

(21) Appl. No.: 15/757,132

(22) PCT Filed: Sep. 5, 2016
(86) PCT No.: PCT/EP2016/070802

§ 371 Date: Aug. 20, 2018

(30) Foreign Application Priority Data
Sep. 4, 2015 (FR) 1558227

(51) Int. Cl. G06F 21/32; G06F 21/31

(52) U.S. Cl. CPC G06F 21/32; G06F 21/316

(57) ABSTRACT

A method for authorizing an action via authentication of a user for a device comprising sensors and emitters, a processor, and a memory. The method comprises: requesting the processor perform an action, verifying the level of authentication required by the user for performing the action, adjusting the user's level of authentication when the level of authentication is insufficient, authorizing the action, wherein adjusting the user's level of authentication comprises: emitting at least one random or non-random sequence of stimuli to the user, capturing behavioral biometric data on the user's reactions to the emitted stimuli, by recording the actuated sensor(s) and the type of action performed on the sensor provided by the received signal, validating the user's response by comparing the reaction performed by the user on the basis of the response to the stimuli previously recorded in the memory, with an expected response allowing validation of user authentication.

### TECHNICAL FIELD OF THE INVENTION

The present invention generally relates to the field concerning methods for authorizing an action via interactive and intuitive authentication, intended for example for children and persons not having the capability of storing a code.

It also relates to a device using such a method and more particularly a moneybox.

### STATE OF THE PRIOR ART

It is known that methods for authorizing an action via authentication generally use a login and password.

However, these systems are not particularly adapted for all persons and in particular not for children. In general, children never use randomly generated passwords. Their passwords are therefore easy to guess. In addition, most often they share their passwords with friends or family, which reduces the security provided by these types of systems.

There is therefore a need for an authentication system that does not require the use of a login/password pair, whilst remaining simple and intuitive for use for example by children.

Patent application US 2010/0115610 discloses a method for authenticating a user on the basis of behavioral biometric data associated in particular with keyboard entry. Such a method allows a substantial increase in the security of systems using a login/password pair.

However, such methods are not adapted for children of young age. These methods are effectively designed for adults and are not in any way intuitive.

Patent application US 2007/0261109 discloses an authentication system applied to a computer screen and not requiring a login/password pair. The authentication system uses a multiple-choice questionnaire in story form, the choice made among possible answers allowing identification of the user.

Patent application US2007/0277224 also discloses an alternative system characterized by choice of an image from a multitude of images.

Both these systems are recreational and intuitive, but they are not adapted however for devices not having a screen or if the user is unable to read.

Another possibility for identifying a person is to use the person's biometric data such as fingerprints, recognition of voice, iris or vein network.

However, for this type of technology to perform well, it is generally of very high cost. Especially as these technologies are generally not designed for persons having characteristics that may evolve over time.

### DESCRIPTION OF THE INVENTION

The objective of the invention is therefore to propose a method for authorizing an action via interactive and intuitive authentication of a user, allowing at least some of the disadvantages of the prior art to be overcome.

Such a method is intended for a device comprising at least one series of sensors and emitters, processing means, a memory and data output means, said method comprises at least:
a step to request the processing means to perform an action;
a step by the processing means to verify the level of authentication required by the user for performing said action;
a step to adjust the user's level of authentication when the level of authentication is insufficient to perform said action;
a step by the processing means to authorize said action;
   characterized in that said step to adjust the user's level of authentication comprises the following sub-steps:
a step by at least one emitter to emit at least one random or non-random sequence of at least two stimuli to the user;
a step to capture behavioral biometric data on the user's reactions to said stimuli emitted at the emission step, by recording the actuated sensor(s) and the type of action performed on the sensor provided by the received signal;
a step to validate the user's response at the step to capture behavioral biometric data performed by said processing means by comparing said reaction performed by the user on the basis of the response to the stimuli previously recorded in the memory, with an expected response defined by a conditioning or learning step allowing validation of user authentication.

By “behavioral biometry” is meant any biometric data based on recognition of a behavioral feature learnt and acquired over time, rather than that of a physiological characteristic. In particular, behavioral biometry is based on measurements and data relating to an action of a person. For example, it allows identification of a user via their manner of movement, interaction with the environment when confronted with a recurrent situation, manner of holding a pen when signing a document or keystroke manner.

Therefore, by means of such a method, a child can be formally identified without having to store a password. In addition, the child has the impression that enrolling and being authenticated is a game, making the authentication method fun, interactive and intuitive.

In one particular aspect, the method comprises at least one prior step for conditioning or learning of said device by storing expected response(s), wherein:
at least one emitter individually produces each unique and distinctive stimulus composing said sequence of stimuli to the user;
the user responds to each unique and distinctive stimulus by a reaction detectable by said at least one sensor, selected from actions associated with a behavioral biometric of the user;
the user reaction in response to each unique and distinctive stimulus is stored in the memory;
the user is notified, by the data output means, of the successful storing of his behavioral biometric reaction associated with a unique and distinctive stimulus.

In another particular aspect, the number of stimuli emitted in the random or non-random sequence is related to the desired level of authentication.

In another particular aspect, each of the unique and distinctive stimuli composing said sequence is produced by a sound, light, image, vibration or scent emitter respectively causing visual, auditive and/or touch-sensitive type perception by the user.

In another particular aspect, each of said actions associated with a behavioral biometric in response to a unique and distinctive stimulus is of sound, touch-sensitive and/or body language type.

In another particular aspect, at the prior conditioning step, when the user responds to a unique and distinctive stimulus, his behavioral biometric reaction is compared by the processing means with the reactions previously stored, if this reaction is identical to one of the reactions previously stored, the user is prompted to reiterate a new response, to the unique and distinctive stimulus, different from that previously given.

A further subject of the application is an electronic device comprising at least one series of series and emitters, processing means, a memory and data output means, characterized in that the processing means is composed of at least one microprocessor and an associated program allowing implementation of the method for authorizing an action via interactive and intuitive authentication of a user according to the invention.

Preferably, said electronic device is a moneybox, more advantageously a connected moneybox.

In another particular aspect, at least one emitter is a vibrating means, a colored light, a siren, a loud-speaker, an articulated element, a scent diffuser or a combination thereof.

In another particular aspect, at least one sensor is a switch, an accelerometer, a gyro sensor, a microphone, a camera, a movement detector, a touch-sensitive region or a combination thereof.

In another particular aspect, the moneybox is of animal shape comprising at least one articulated element from the following elements: paws or feet, head, snout or trunk or nose, mouth or muzzle, tail and ears, said at least one articulated element being provided with at least one sensor sensing movement of the articulated element, arranged in or close to the articulation to deliver a signal interpretable by the behavioral biometry recognition software and/or to trigger another stimulus.

In another particular aspect, the moneybox comprises at least one touch sensitive sensor on at least one flank and/or on its back.

In another particular aspect, the moneybox further comprises two-way communication means with a server of a bank holding a bank account of the user and/or with a mobile application.

Preferably, such a two-way communication means is wireless e.g. of WiFi, Bluetooth, NFC, radio, cell, LiFi, infrared type.

Preferably, the processing means authorizes transmission of data by the communication means only when the user's level of authentication is sufficient.

In another particular aspect, the processing means authorizes the execution of an action as a function of the user's level of authentication and the user's age.

Therefore, such a moneybox of the invention is an age-scalable, educational means allowing the teaching of money management in a manner that is fun and interactive.

### BRIEF DESCRIPTION OF THE FIGURES

Other characteristics, details and advantages of the invention will become apparent on reading the following description with reference to the appended Figures, in which:

FIG. 1 gives a flowchart of a method for authorizing an action via interactive and intuitive authentication of a user, according to the invention;

FIG. 2 is a detailed flowchart of the steps for authentication used by the method for authorizing an action via interactive and intuitive authentication of a user, according to the invention;

FIG. 3 illustrates a moneybox of the invention.

### DETAILED DESCRIPTION OF DIFFERENT EMBODIMENTS OF THE INVENTION

In general, the method of the invention is applied by an electronic device comprising at least ane series of behavioral biometric sensors and emitters, processing means and a memory. Said processing means is composed of at least one microprocessor and an associated program allowing implementation of the method for authorizing an action via interactive and intuitive authentication of a user, according to the invention.

The method for authorizing an action via interactive and intuitive authentication of a user is based on behavioral biometric data of the user. The use of such data allows greater interaction with the user and is highly suitable for example for children or any person not able to use a login/password pair. In particular, said method uses behavioral biometric data of a child for example, acquired in response to sound, visual or touch-sensitive stimuli.

More particularly, the authentication steps are carried out in the form of challenges thereby allowing an interactive and intuitive method to be obtained that is adapted for children.

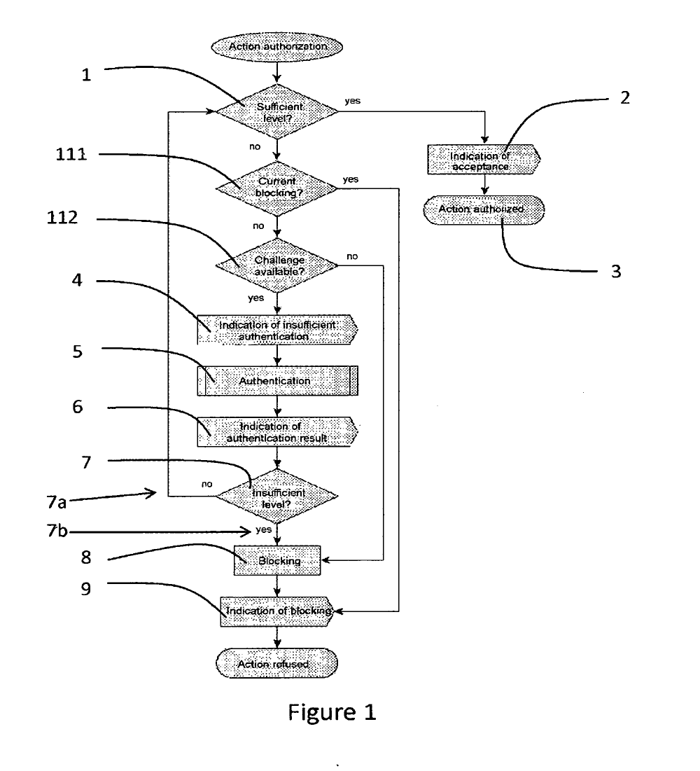

For example, as illustrated in FIG. 1, a method for authorizing an action via interactive and intuitive authentication of a user, according to the invention, may comprise a first step (1) at which the program determines whether the desired action selected by the user on an interface of the electronic device requires user authentication.

For this purpose, the processing means consults a table or file in the memory to determine, via cross-referencing, the level of authentication corresponding to the action in order to authorize said action.

If the user's current level of authentication (also called score) is equal to or higher than the required level, the processing means informs the user via an indication (visual, audio or touch-sensitive) of acceptance of the action request (2) and authorizes said action (3).

If the user's current level of authentication recorded is lower than the level required, the processing means informs the user (4) and prompt the user to give authentication (5) by generating another indication (visual, audio or touch sensitive).

After the authentication step (5), the user is informed by the device of the result (6), and the processing means compares the user's new score with the required level (7):
If authentication of the user is successful (7a), the user's level of authentication or score is increased and recorded so that it is equal to or higher than the level required to perform said action, and the processing means then authorize said action (2 and 3).
If authentication is not positive, the user's level of authentication or score remains insufficient to carry out the action (7b). The processing means then blocks the action (8) informing the user thereof (9) by a command generating an indication (visual, audio or touch-sensitive).

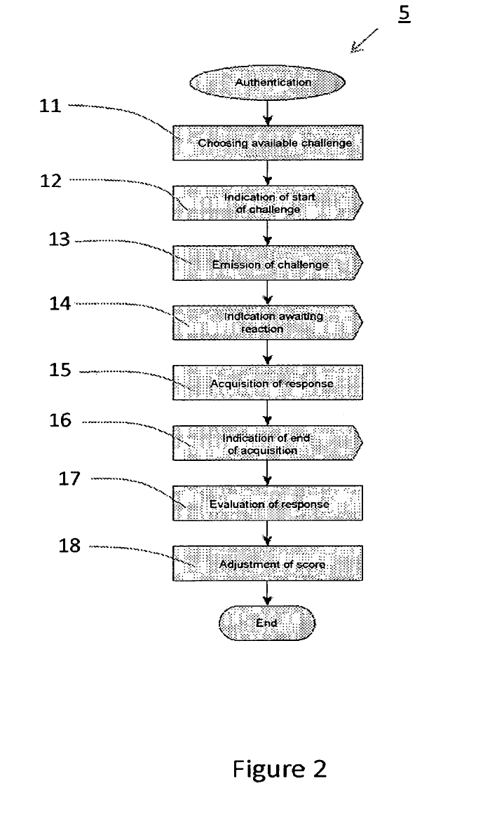

The user authentication step (5) comprises the following sub-steps illustrated in FIG. 2:
the random selection of a challenge (11) by the processing means from the memory i.e. a stimuli sequence associated with a level equal to or higher than the required level of authentication to authorize the action. In other words, said stimuli sequence is composed of a number of unique and distinctive stimuli corresponding at least to the level of authentication required to authorize the action;
sending of a command, by the processing means, generating an indication (visual, audio or touch-sensitive) of the start of the challenge (12), to the user;
emitting of the challenge by at least one emitter i.e. a sequence of stimuli corresponding to the level of authentication (13) required for the action;
sending of a command, by the processing means, generating an indication (visual, audio or touch-sensitive), awaiting the user response to the sequence of stimuli of the challenge (14);
acquisition by at least one sensor of each user reaction to each unique and distinctive stimulus composing said sequence and recording thereof by the processing means in the memory for processing (15);
sending of a command, by the processing means, generating art indication (visual, audio or touch-sensitive) of the end of acquisition of the user response (16);
evaluation, by the processing means, of the recorded response by comparison with an expected response to the sequence of stimuli, this expected response having been defined and stored at a prior conditioning or learning step of the device;
adjusting the user score as a function of the result of evaluation:
   if evaluation is positive, the level of authentication is incremented and recorded by the processing means to reach at least the level corresponding to the challenge taken up, and thereby allowing the user to obtain a level equal to or higher than the level of authentication required to authorize the action;
   if evaluation is negative, the level of authentication can remain unchanged or can be decreased and recorded by the processing means.

In one alternative embodiment, not illustrated, the authentication step may comprise a so-called general challenge in the form of a succession or reiteration of sub-challenges to be completed before finishing the general challenge. Each sub challenge is then composed of the emission of a single unique and distinctive stimulus. The number of sub-challenges being defined by the level of authentication required to carry out the action.

Irrespective of the authentication step used in the method of the invention, for self-authentication a user must previously have parameterized the electronic device at a conditioning or learning step so that the memory records the behavioral biometric data of the user.

It is only once said electronic device has been conditioned by the user that it is able to authenticate said user.

To do so, said electronic device via at least one emitter emits a unique and distinctive stimulus which may be visual, sound, touch-sensitive or a combination thereof.

The user responds to said stimulus by interaction with said device, this interaction is detected by at least one behavioral biometric sensor of the electronic device and its signal is recorded in the memory by means of the processing means. This specific interaction, to said produced stimulus, corresponds to the behavioral biometric of the user in reaction to this specific stimulus. The at least one sensor does not record any physiological biometric of the user in response to said stimulus.

These steps are repeated as many times as necessary so that all the stimuli which may be emitted by said electronic device can be associated with a specific interaction characterizing a behavioral biometric of the user in reaction to a unique and distinctive stimulus and can be stored in the memory.

Finally, it is preferable that the electronic device via an indication (visual, sound and/or touch-sensitive) emitted via a command generated by the processing means, informs the user of the successful recording in memory of the user's behavioral biometric reaction associated with the unique and distinctive stimulus.

An optional sub-step can be implemented at the conditioning or learning step of the device, at which the processing means compares the behavioral biometric reaction with the reactions previously recorded in memory, if this reaction is identical to one of the previously stored reactions, in which case the user is prompted to reiterate a new response to the unique and distinctive stimulus differing from the one previously given.

This sub-step therefore prevents user responses from being identical irrespective of the unique and distinctive stimulus produced by the device, and thereby reinforces authentication.

In one alternative embodiment, optional steps can be contained between the different steps listed above.

For example, a step may be included between steps (1) and (4) to determine whether there is blocking prior to action since the required level of authentication cannot be reached by the user. This may be caused by:
a temporary or permanent restriction of the desired action (111);
absence of a challenge validating the required level of authentication (112).

In another embodiment, modification of the level of authentication may be associated with other parameters such as age, size, weight, PIN code, non behavioral biometric such as fingerprint, voice, iris or vein network.

In another embodiment, the user's level of authentication decreases when the challenge is not validated.

In another embodiment, the user's level of authentication decreases automatically after a period of inactivity.

In another embodiment, when the level of authentication is too low, the device is temporarily blocked.

In another embodiment, the user is informed of the different steps by display means or sound means.

In another embodiment, an action requiring a high or very high level of authentication can be carried out only if the required level of authentication is reached in combination with confirmation on another electronic device.

In another embodiment, the method executed by the processing means allows the use of weighting in respect of the choice of challenges used, this weighting giving priority or not to some challenges, so as to adapt the challenges to the user e.g. as a function of the user's age, handicap, etc.

In another embodiment, the method executed by the processing means enables the user, via a menu, to choose or personalize the challenge or part of the challenge allowing user authentication. Such a characteristic allows reinforced authentication in the same manner as the “personal question” used in some authentication methods on computing equipment. Not only is the response given be the user a feature associated with their behavioral biometric, but the choice of challenge or part of challenge is also another feature associated with their behavioral biometric.

It is evidently obvious for persons skilled in the art to combine the different embodiments without departing from the invention. Skilled persons will make their choice as a function of economical, ergonomic, dimensional or other constraints that must be heeded.

A further subject of the invention is an electronic device comprising at least one series of sensors and emitters, processing means, a memory and data output means, which said processing means is composed of at least one microprocessor and an associated program allowing implementation of the method for authorizing an action via interactive and intuitive authentication of a user according to the invention. Preferably, the data output means are one or more light-emitting diodes, a loud-speaker or screen. If the data output means are a screen, it is not used as an emitter if the device emits a random or non-random sequence of at least two stimuli to the user by solely one emitter. In other words, if solely a single emitter of a series of emitters contained in the device is used, to produce the random or non-random sequence of at least two stimuli, then the screen for data output will not be used.

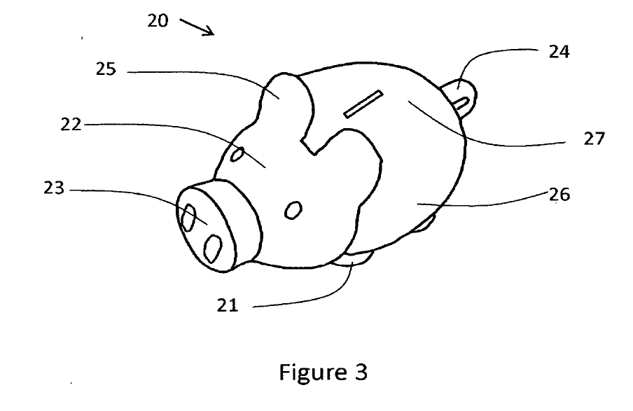

In particular, as shown in FIG. 3, such a device may be a moneybox (20), in particular a connected moneybox, more particularly intended for one or more children.

The use of the method for authorizing an action via interactive and intuitive authentication according to the invention is particularly adapted for a moneybox, and more particularly when it is connected to a bank account at a bank via two-way communication means.

As an example, the method of the invention may authorize at least the following actions after authentication in accordance with the method:
Adding cash;
Adding money via transfer or online payment;
Consulting the local balance (in the moneybox);
Consulting the balance of the bank account;
Withdrawing money from the moneybox;
Transfer from the bank account to another account.

Evidently, the above list is given by way of example and is not to be construed as being limiting.

Each of these actions may have identical levels of authentication in some embodiments, but preference may be given to levels of authentication in proportion with the importance of the action.

For example:
Adding cash: zero or very low level of authentication required e.g. a sequence comprising 1 or 2 stimuli (score);
Adding money via transfer: zero or very low level of authentication required e.g. a sequence comprising 1 or 2 stimuli (score);
Consulting local balance (in moneybox): low level of authentication required e.g. a sequence comprising 2 to 4 stimuli (score);
Consulting bank account balance: medium level of authentication required e.g. a sequence comprising 4 to 6 stimuli (score);
Removing money from the moneybox; high level of authentication required e.g. a sequence comprising 6 to 10 stimuli (score);
Transfer from the bank account to another account: very high level of authentication required e.g. a sequence comprising more than 10 stimuli (score).

For this purpose, the body of the moneybox carries a series of emitters and sensors.

As a solely illustrative and nonlimiting example:
an emitter may be a vibrating means, a colored light, a siren, a loud-speaker, an articulated element, a scent diffuser or a combination thereof;
a sensor is a switch, an accelerometer, a gyro sensor, a potentiometer, a microphone, a camera, a movement detector, a touch-sensitive region or a combination of these different elements.

Therefore, when the method of the invention is implemented by the moneybox, each unique and distinctive stimulus of the sequence may be: movement of part of the moneybox, a beep or sound sequence, vibration or vibration sequence, illumination of all or part of the moneybox, or light sequence. Color illumination may be monochromatic or changing.

The responses given by the user, or data associated with user responses further to a stimulus, are associated with a so-called behavioral biometric file of the user. For example, such data may represent a movement of the user captured by a camera, or activation of a switch on the body of the moneybox, or an articulated/mobile element of the moneybox, or a sound, a word or phrase captured by the microphone or displacement of the moneybox by the user recorded by the accelerometer and/or gyro sensor, or contact between the user and the moneybox monitored by the touch-sensitive region. The term behavioral biometric file is to be understood in its broad meaning in that it records not only the type of response to stimuli, but also possibly the acquisition of continuous magnitudes for example the time between two actions, to push a push button, or relating to the sound of the voice, or the time to perform movement on a touch-sensitive region or to carry out movement on a rotating knob . . . .

For example, if when conditioning the moneybox, the user says “POLO” in response to the sound stimulus “MARCO”, or lifts up the moneybox in response to a red-colored illumination, the user's responses associated with the behavioral biometrics of the user will be expected at the time of challenges using the stimuli “MARCO” and red-light illumination, in order to validate the challenges and increase the user's score to authorize the desired action.

Evidently, it is possible for a single stimulus to record a complex response comprising behavioral biometrics captured by several sensors simultaneously. For example, when the stimulus is a red light the recorded user response is upward movement of the moneybox with two pressure points on the touch-sensitive region located on the top surface of the moneybox. Such an embodiment substantially reinforces user authentication.

Since the moneybox of the invention is intended for children, the shape of the moneybox is preferably an animal shape, thereby facilitating playful interaction with children.

With such a shape it is effectively possible to position one of more articulated elements from a part or parts of the animal's body such as paws or feet (21), head (22), snout or nose or trunk (23), mouth or muzzle, tail (24) and ears (25).

These articulated elements can be provided with at least one sensor sensing movement of the articulated element, arranged in or close to the articulation, so as to deliver a signal interpretable by the behavioral biometry recognition software when the user handles the articulation in response to a stimulus.

Similarly, when the shape the moneybox is an animal, the position of any touch-sensitive region is preferably on the flanks (26) and/or back (27) of the animal.

Also, if the moneybox is a connected moneybox i.e. it is connected to a bank account, the moneybox further comprises two-way communication means with a server of a bank holding the user's bank account and/or with a mobile application.

In this particular embodiment, the actions requiring a high or very high level of authentication may require confirmation by the server or execution of the mobile application on a telephone to allow improved security and greater control, in particular parental control.

In another embodiment, the moneybox may have scalable functionalities, actuated by a server or controller such as a tablet computer or mobile telephone, as a function of the user. That is to say that some functions and hence authorizations for action will be available for processing by the authentication method as a function of the user's age or of additional control means e.g. parental. For example, up to 3 years only the adding of money is available, from 3 to 7 years consultation of the balance becomes available, and on and after 9 years transfers with a bank account become available and transfers to micro-payment means/electronic wallet, etc.

In addition, in some embodiments, the presence of a link with a server or controller allows the sending of commands adapted for regular updating of the moneybox via the communication means.

Such updates may allow the receiving of code sequences allowing:
integrating new challenges in the device;
deleting challenges not giving expected results for authentication (e.g. challenges giving false positives or false negatives);
adding or unblocking new functions;
modifying levels of authentication required to carry out an action.

In addition, the moneybox of the invention may implement the following schemes of use under the supervision of the method of the invention:
Savings: insertion of a coin, banknote or bank check in the moneybox, detection thereof by a coin sensor or banknote/check scanner, transmission of the data to the server and display thereof on a mobile application. In one alternative embodiment, confirmation of the amount inserted in the moneybox may be requested by the server by means of the mobile application.
Electronic receiving of money: the moneybox sends data to an application held by a nonuser third party allowing identification of the bank account associated with the user of the moneybox. The sending of data can be performed by the communication means directly via wireless communication between the moneybox and an application (e.g. mobile) held by a third party (Wifi, NFC, Bluetooth, infrared, LiFi), via reading of a QR code or via the server of the user's bank. The third party makes the transfer, the bank server transmits the information to the moneybox which records the same and informs the user thereof.

Furthermore, irrespective of the embodiment, the moneybox of the invention may have:
a game mode wherein the processing means implements the challenges of the authentication step in playful manner;
a nightlight mode can be implemented by activating light emitters;
a baby phone mode for example by pairing transmission with an application embedded on a cell phone.

It will easily be understood on reading the present application that the particular aspects of the present invention as generally described and illustrated in the Figures, can be arranged and designed in a large variety of different configurations. Therefore, the description of the present invention and related Figures are not intended to limit the scope of the invention, but merely illustrate selected embodiments.

Persons skilled in the art will understand that the technical characteristics of a given embodiment can be combined with characteristics of another embodiment unless the reverse is explicitly mentioned or it is obvious that these characteristics are incompatible. Also, the technical characteristics described in a given embodiment can be isolated from the other characteristics of this embodiment unless the reverse is explicitly mentioned.

It will be obvious for skilled persons that the present invention allows embodiments in numerous other specific forms without departing from the field defined by the scope of the appended claims; the embodiments are to be construed as illustrations and the invention is not to be limited to the details given in the foregoing.

1. A method for authorizing an action via a multi-level interactive and intuitive authentication of a user for a device comprising at least one series of behavioral biometric data sensors, and a series of emitters of which at least one emitter differs from a screen, a processor, a memory and data output, said method comprises at least:
a) a step to request the processor to perform an action,
b) a step by the processor to verify the level of authentication required by the user for performing said action,
c) a step to adjust the user's level of authentication when the level of authentication is insufficient to perform said action,
d) a step by the processor to authorize said action;
wherein said step to adjust the user's level of authentication is performed within the device and comprises the following sub-steps:
i) a step by at least one emitter to emit al least one random or non-random sequence of at least two stimuli to the user,
ii) a step to capture behavioral biometric data on the user's reactions to said stimuli emitted at the emission step, by recording the actuated sensor(s) and the type of action performed on the sensor provided by the received signal,
iii) a step to validate the user's response at the step to capture behavioral biometric data performed by said processor by comparing said reaction performed by the user on the basis of the response to the stimuli previously recorded in the memory, with an expected response defined by a conditioning or learning step allowing validation of user authentication.

2. The method for authorizing action via interactive and intuitive authentication of a user according to claim 1, wherein said method comprises at least one prior step for conditioning or learning of said device by storing expected response(s), wherein:
i) at least one emitter individually produces each unique and distinctive stimulus composing said sequence of stimuli to the user,
ii) the user responds to each unique and distinctive stimulus by a behavioral reaction delectable by at least one sensor, this reaction having to correspond to one of the actions associated with a behavioral biometric of the user,
iii) each user behavioral reaction in response to each unique and distinctive stimulus is stored in the memory,
iv) the user is notified, by the data output means, of the successful storing of his behavioral biometric reaction associated with a unique and distinctive stimulus.

3. The method for authorizing an action via interactive and intuitive authentication of a user according to claim 1, wherein the number of stimuli emitted in the random or non-random sequence is related to the desired level of authentication.

4. The method for authorizing an action via interactive and intuitive authentication of a user according to claim 1, wherein each of the unique and distinctive stimuli composing said sequence is produced by a sound, light, image or vibration emitter respectively causing visual, auditive and/or touch-sensitive type perception by the user.

5. The method for authorizing an action via interactive and intuitive authentication of a user according to claim 1, wherein each of said actions associated with a behavioral biometric in response to a unique and distinctive stimulus is of sound, touch-sensitive and/or body language type.

6. The method for authorizing an action via interactive and intuitive authentication of a user according to claim 2, wherein at the prior conditioning step, when the user responds to a unique and distinctive stimulus, his behavioral biometric reaction is compared by the processor with the reactions previously stored, if this reaction is identical to one of the reactions previously stored, the user is prompted to reiterate a new response, to the unique and distinctive stimulus, different from that previously given.

7. An electronic device comprising at least one series of sensors and emitters, a processor a memory and data output means, wherein the processor is composed of at least one microprocessor and an associated program allowing implementation of the method for authorizing an action via interactive and intuitive authentication of a user according to claim 1.

8. The electronic device according to claim 1, wherein the electronic device is a moneybox.

9. The electronic device according to claim 8, wherein at least one emitter is a vibrator, a colored light, a siren, a loud-speaker, an articulated element or a combination thereof.

10. The electronic device according to claim 8, wherein at least one sensor is a switch, an accelerometer, a gyro sensor, a microphone, a camera a movement detector, a touch-sensitive region or a combination thereof.

11. The electronic device according to claim 8, wherein the electronic device is of animal shape comprising at least one articulated element from the following elements: paws or feet, head, snout or trunk or nose, mouth or muzzle, tail, and ears, said at least one articulated element being provided with at least one sensor sensing movement of the articulated element, arranged in or close to the articulation to deliver a signal interpretable by the behavioral biometry recognition software and/or to trigger another stimulus.

12. The electronic device according to the claim 1, comprising at least one touch-sensitive sensor on at least one flank and/or on its back.

13. The electronic device according to claim 8, further comprising two-way communication means with a server of a bank holding a bank account of the user and/or with a mobile application.

14. The electronic device according to claim 13, wherein the processor authorizes transmission of data by the communication means only when the user's level of authentication is sufficient.

15. The electronic device according to claim 13, wherein the two-way communication means allows the receiving of commands adapted for updating the moneybox.

16. The electronic device according to claim 15, wherein the updates comprise at least one of the following actions:
integrating one or more new challenges,
deleting one or more challenges not giving expected results for authentication,
adding or unblocking one or more new functions, or
modifying one or more levels of authentication required to carry out an action.

17. The electronic device according to claim 8, wherein the processor authorizes the execution of an action as a function of the user's level of authentication and the user's age.
